(19) United States
(12) Patent Application Publication
(10) Pub. No.: US 2025/0358281 A1
(43) Pub. Date: Nov. 20, 2025

(54) Method for securely sending an email

(71) Applicant: MAILSPEC SAS, NICE (FR)

(72) Inventor: Jon Doyle, Nice (FR)

(21) Appl. No.: 19/279,907

(22) Filed: Jul. 24, 2025

Related U.S. Application Data
(62) Division of application No. 18/316,950, filed on May 12, 2023.

(30) Foreign Application Priority Data
Mar. 24, 2023 (FR) 2204976

(51) Int. Cl. H04L 9/40

(52) U.S. Cl. CPC H04L 63/0861; H04L 63/0428; H04L 63/083

(57) ABSTRACT

A method of securely sending (200a) an electronic mail, with the method (200a) comprising: receiving, at an electronic mail server (102) a request from a user to send the electronic mail, with the user having an electronic mail account on the electronic mail server (102), and the user having previously identified himself to the electronic mail account; in response to receiving the request, the server (102) sending a security test to be completed by the user to a trusted apparatus (104) associated with the user via a secure channel; the server (102) receiving the security test completed by the user via the secure channel; server (102) validating the security test completed by the user; and server (102) sending the electronic mail if the test is validated by the user.

### FIELD OF THE INVENTION

The technical field of the present invention concerns the secure sending and receiving of electronic mails.

### PRIOR ART

Sending and receiving of emails are governed by several protocols: SMTP for sending a letter and POP and IMAP for returning the letter to be read by a user. The sender's MUA (mail user agent) sends the email to a server via SMTP. The server routes the message to the recipient's server. The recipient's server delivers to an MDA (Mail Delivery Agent) which is responsible for mailbox management. The recipient, via its MUA, asks the MDA for the new messages using the IMAP or pop protocols. The server sends the message to the recipient's MUA.

However, the protocols used for sending and receiving emails were invented before high-speed Internet was in use. In addition, there are many types of emails from different email services. For this reason, it is difficult to secure the sending and receiving of emails.

In addition, email services require authentication with a username and password. However, if the username and password are obtained by someone other than the user, for example, when using passwords that are easy to guess, other users may send malicious emails or access confidential data.

### SUMMARY OF THE INVENTION

The invention improves the situation by offering a method of securely sending electronic mail. In fact, the present invention proposes a double authentication, making it possible to ensure that the user associated with a messaging service is also the user sending an electronic mail from this same messaging service.

In addition, it is noted here that the protocols used for sending and receiving emails, due to the age of this technology, include a delay between the time a user wishes to send an email (for example, by clicking on “send”) and the time it is actually sent. Thus, the method described in the present application takes advantage of this delay, because an authentication can be carried out during this delay.

Similarly, a method for secure receipt of electronic mail is also described, which also uses a double authentication, making it possible to ensure that the user associated with a mail service is also the user receiving an electronic mail from this same mail service.

Thus, the invention improves the situation by proposing a method of securely sending an electronic mail, with the method comprising: receiving, at a request from a user to send the electronic mail, with the user having an electronic mail account on the electronic mail server, the user having been previously identified with the electronic mail account; in response to receiving the request, using the server to send a security test to be completed by the user to a trusted device associated with the user via a secure channel; the server receiving the security test completed by the user, via the secure channel; using the server to check the security test completed by the user; and sending the electronic mail by the server if the test is validated by the user.

In addition, the invention improves the situation by offering a method of securely sending an electronic mail, the method comprising: receiving, at a trusted device associated with the user in response to receiving a request for transmission of an electronic mail by a server, a security test to be completed by the user via a secure channel; the user completing the security test on the secure device; transmitting the security test completed by the user, to the server, via the secure channel for validation and transmission of the electronic mail by the server if the test is validated by the user.

In addition, the invention improves the situation by proposing a method of detecting a request to send an electronic mail, with the method comprising: an electronic mail server receiving a request from a user to send the electronic mail, with the user having an electronic mail account on the electronic mail server, [and] the user having previously been identified with the electronic mail account; in response to receiving the request, using the server to send a security test to be completed by the user, to a trusted device associated with the user via a secure channel; the server receiving the security test completed by the user, via the secure channel; checking the security test completed by the user by the server; and rejecting the electronic mail or sending it by the server to a recipient other than that specified in the message if the test is not validated by the user.

In one manner of embodiment, the method further comprises: receiving, at the email server, another request from the user to send another email; verifying a predetermined security parameter; sending the email by the server if the predetermined security parameter is satisfied.

In one manner of embodiment, the security parameter comprises: an elapsed time between sending the request and the other request, a change of IP address used by the user and a date on which the request is sent by the user.

In one manner of embodiment, the security test consists of comparing a biometric input with biometric data associated with the user and stored on the trusted device associated with the user.

In one manner of embodiment, the trusted device associated with the user is a mobile phone or a USB stick.

In one manner of embodiment, the trusted device includes an application for completing the security test.

Furthermore, the invention improves the situation by offering a computer programme product comprising instructions which, when the programme is executed by a computer, cause the computer to implement the methods described above.

In addition, the invention improves the situation by offering a server allowing the secure sending of an electronic mail, with the server being configured to implement the method of secure sending of an electronic mail.

In addition, the invention improves the situation by offering a trusted device allowing secure sending of an electronic mail, with the trusted device being configured to implement the method of secure sending of an electronic mail.

In addition, the invention improves the situation by proposing a method of secure reception of an electronic mail by a user, with the method comprising: an electronic mail server receiving a request to receive the electronic mail, with the user having an electronic mail account on the electronic mail server, and the user having previously identified himself with the electronic mail account; in response to receiving the request, sending, by the server, a security test to be completed by the user to a trusted device associated with the user via a secure channel; the server receiving the security test completed by the user via the secure channel; the server checking the security test completed by the user; receiving the electronic mail by the server; and the server sending the electronic mail to the user if the test is validated by the user.

Method of securely receiving an electronic mail by a user, the method comprising: receiving, at a trusted device associated with the user, in response to receiving a request to receive an electronic mail by a server, a security test to be completed by the user via a secure channel; and completing the security test by the user on the trusted device; transmitting the security test completed by the user to the server via the secure channel for validation and transmission of the mail to the user by the server if the test is validated by the user.

### BRIEF DESCRIPTION OF THE DRAWINGS

Other characteristics, details and advantages of the invention will become apparent on reading the description given with reference to the appended drawings given by way of example and which represent, respectively:

FIG. 1 is a schematic representation of an example of a system allowing the secure sending of an electronic mail;

FIG. 2a is an example of a method for securely sending an electronic mail;

FIG. 2b is an example of a method for securely sending an electronic mail;

FIG. 3a shows an example of a method for secure reception of an electronic mail; and

FIG. 3b shows an example of a method for secure reception of an electronic mail.

### DETAILED DESCRIPTION

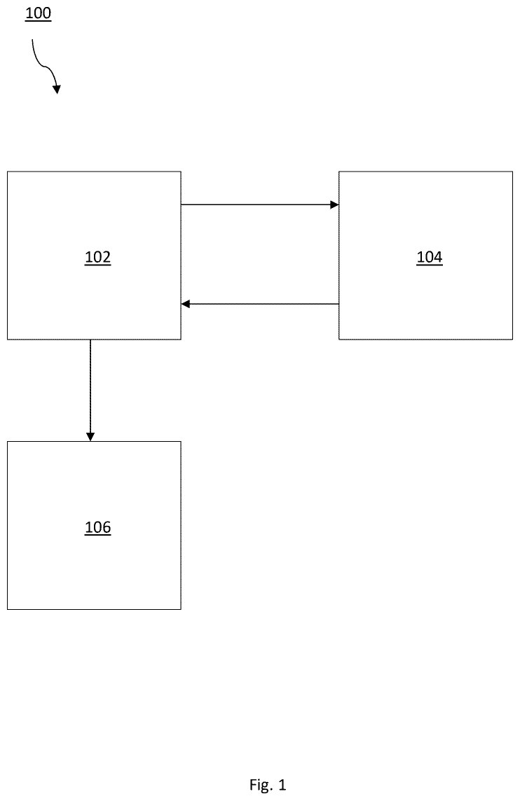

FIG. 1 illustrates an example of system 100 allowing secure sending of electronic mail.

The system 100 comprises an electronic messaging server 102. A user has an e-mail account on the server 102. The user has previously logged in to the email account. The server may be, for example, on a local area network of the user. The server 102 being configured to receive a request from the user to send the electronic mail. For example, the electronic mail server 102 may be a server 102 that the user accesses via a personal computer or a work computer, allowing him to access one or more electronic mailboxes. In order to use his electronic messaging linked to the server 102, the user has previously authenticated himself by means of a user name and a password. When the user attempts to send an electronic mail that he/she has written from his/her electronic mail, a request to send the electronic mail is transmitted to server 102.

Furthermore, the system 100 comprises a trusted device 104 associated with the user, where trusted device 104 is configured to receive a security test sent by the server to be completed by the user and send the completed test to server 102 via a secure channel. For example, secure device 104 may be a mobile telephone, such as a smart phone, or a tablet or even a smart watch associated with the user. The trusted device 104 may also be a USB stick that has a device for inputting a biometric input.

The security test may consist of a comparison between a biometric input with biometric data associated with the user and stored on trusted device 104 associated with the user. For example, the trusted device 104 may include a device for generating biometric data such as a fingerprint, facial recognition, iris scan, or voice analysis sensor. Trusted device 104 can ask the user to enter his biometric data, for example his fingerprint, by placing his finger on the biometric sensor using his mobile phone or his USB stick. In another example, the biometric data may be facial recognition or a vital sign such as the user's pulse or breathing. Trusted device 104 verifies that the fingerprint corresponds to that of the user. For example, trusted device 104 may store biometric data associated with one or more users previously entered by the user, in order to compare them with the biometric data generated during the security test. Trusted device 104 can emit a result of the completed test. For example, if the biometric data entered by the user correspond to the stored data, trusted apparatus 104 can emit a result indicating that the data are those of the user. On the other hand, if the biometric data entered by the user do not correspond to the stored data, trusted apparatus 104 can emit a result indicating that the data are not those of the user. In one example, trusted apparatus 104 may determine that the biometrics entered by the user correspond to the stored data when trusted apparatus 104 determines that the biometric input meets a predefined similarity criterion with respect to the biometric data associated with the user. For example, the similarity criterion may correspond to a similarity threshold between the biometric input and the biometric data associated with the user. In another example, the security test may include a password. For example, the user can receive a notification on the trusted device 104 telling him to enter a password. The password may be a temporary password sent to the trusted device 104, such as a number sent to the user's mobile phone and which is usable for a few minutes. In another example, the password may be a permanent password previously created by the user. In another example, the test may be to answer a question whose answer has been previously recorded on the trusted apparatus 104 associated with the user.

In one example, the trusted apparatus 104 comprises an application for completing the security test. The application may be installed beforehand on the trusted device 104. For example, the application may store the biometric data associated with the user. For example, the application may be associated with a programming interface that enables the user to record his biometric data beforehand.

Thus, when the request to send the electronic mail is transmitted to server 102, server 102 sends the security test to be completed by the user, to the trusted apparatus 104 associated with the user, via a secure channel. The secure channel is an encrypted channel. For example, server 102 and trusted apparatus 104 can communicate by encrypting the security test for each other using a session key. In addition, in one example, a block encryption algorithm (such as SEED) may be used to establish encryption of the secure channel. For example, the user can receive a notification from the application of trusted device 104 indicating that he/she must enter his/her biometric data in order to complete the test. The user can then open the application and complete the security test, for example by entering his biometric data. Once completed, the security test is sent back by the trusted device 104 to server 102 via the secure channel. For example, the test result may be sent by the trusted apparatus 104 to server 102 via the secure channel. In one example, the completed security test can be encrypted using a session key. For example, trusted device 104 can randomly generate the session key which is encrypted with a public key. When the server 102 receives the security test, server 102 can decrypt the session key using a private key.

Server 102 can then validate the security test completed by the user. In one example, trusted apparatus 104 may send to server 102 the biometric data entered by the user and data stored on trusted apparatus 104 that represents biometric data associated with the user. Server 102 can then compare the data entered and the data stored and check the correspondence between the data. In another example, trusted apparatus 104 compares the biometric data and data stored intrusted apparatus 102 representing biometric data associated with the user and generates a result corresponding to a match rate between the data input by the user and the stored data. The match rate can then be sent to server 102. Server 102 can then compare the match rate with a threshold. In another example, trusted apparatus 104 compares the biometric data and data stored in trusted apparatus 104 representing biometric data associated with the user and generates a Boolean indication (e.g.: “validated” or “not validated”). Trusted apparatus 104 then sends the Boolean indication to server 102. For example, when the test result received by server 102 indicates that the data is that of the user, server 102 sends the electronic mail. On the other hand, when the result of the test received by server 102 indicates that the data are not those of the user, the server does not send the electronic mail (for example, removes the electronic mail), or alternatively the electronic mail is sent back to the user instead of being sent to the recipient of the electronic mail. In one example, server 102 may send an error message.

In addition, the system 100 comprises a destination unit 106 that is configured to receive the email if the security test is validated by the server 102. For example, destination unit 106 may be a computer of another user being the sender of the electronic mail sent by the user.

The system 100 described above makes it possible to use double authentication of the user: authentication using an identifier and password to access the email box and authentication at the time an email is sent, with the use of a security test. Thus, system 100 is advantageous because it makes it possible to ensure that the user sends the electronic mail himself and thus avoids phishing or computer piracy.

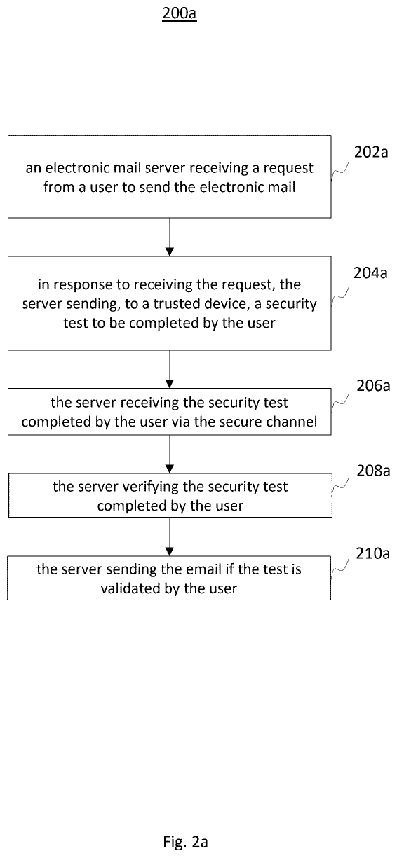

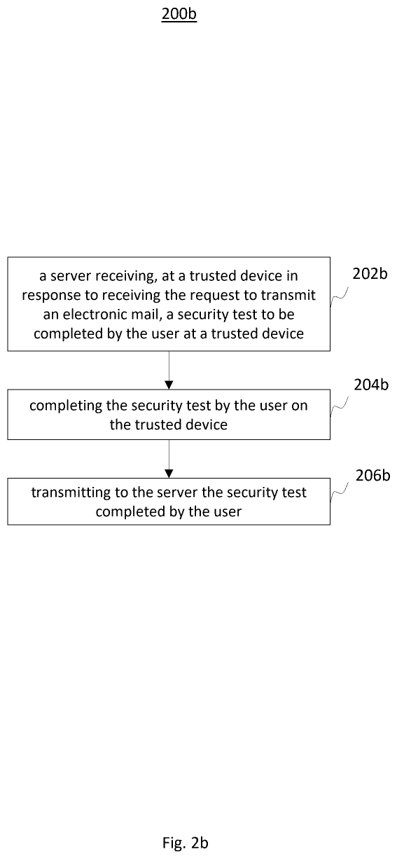

FIG. 2a illustrates an example of method 200a for secure sending of an electronic mail. The method 200a may be implemented by the server 102 described above.

At block 202a, method 200a consists of receiving a request, at an electronic messaging server 102, from a user, to send the electronic mail, where the user has an electronic messaging account on the electronic messaging server 102, and where the user has previously identified himself with the electronic messaging account. The user may identify himself using a user name and password. For example, the user writes an email that he/she wants to send. When the user wishes to send the electronic mail (for example by clicking on “send”), a request is sent to server 102. It should be noted here that at this stage, the email has not yet been sent to the recipient. Server 102 may be on a local network of the user.

At block 204a, method 200a consisting, in response to receiving the request, of sending, using server 102a security test to be completed by the user, to a trusted device 104 associated with the user via a secure channel. In one example, the trusted device 104 associated with the user is a mobile telephone, such as for example a smartphone having a device that makes it possible to generate biometric data. In another example, trusted device 104 is a tablet or a smart watch. In one example, trusted apparatus 104 comprises an application for completing the security test. For example, the user receives a notification on his mobile phone to enter his fingerprint.

At block 206a, method 200a consists of receiving the security test, completed by the user, at server 102 via the secure channel. For example, the server 102 receives the biometric input entered by the user.

At block 208a, method 200a consists of server 102 verifying the security test completed by the user. For example, a comparison between the biometric input entered by the user with biometric data associated with the user. For example, if the biometric input entered by the user corresponds to the biometric data associated with the user, the test is validated. On the other hand, if the biometric input entered by the user does not correspond to the biometric data associated with the user, the test is not validated.

At block 210a, method 200a consists of sending the electronic mail using the server if the test is validated by the user. In fact, if the test is validated, it is ensured that the user who sends the email is in fact the person associated with the email box from which the email is sent.

Alternatively to block 210a, method 200a may consist of rejecting the electronic mail or of the server sending it to a recipient other than that specified in the message if the test is not validated by the user. In fact, if the test is not validated, it means that the user who sends the email is not the person associated with the email box from which the email is sent. For example, the email may be returned to the user who sent the request instead of being sent to the recipient of the email. In one example, an error message may be sent to the user.

In one example, method 200a consists of additional steps comprising: receiving, at e-mail server 102, another request from the user to send another e-mail, verifying a predetermined security parameter and the server sending the e-mail if the predetermined security parameter is satisfied. For example, the security parameter may include a certain number of emails, a certain elapsed time between the validation of the last security test, suspicious behaviour of the user, and the sending of a new request, a change of IP address used by the user since the validation of the last security test, or a date when the request is sent by the user. For example, the user can send several emails successively or simultaneously. If the number of emails is below a predetermined threshold, server 102 sends the email. On the other hand, if the number of emails exceeds the predetermined threshold, server 102 will not send the email. In another example, a request corresponding to suspicious behaviour may be a request to send an email to an entire contact directory of the user. In another example, suspicious behaviour consists of the presence of certain keywords in the electronic mail, with the keywords being defined beforehand. In this case, if server 102 detects suspicious behaviour, server 102 will not send the electronic mail. In another example, when server 102 determines that the user's IP address is the same for several emails sent successively or simultaneously, server 102 sends the email. On the other hand, if the IP address has changed, server 102 will not send the electronic mail. In one example, IP addresses may be previously registered as trusted IP addresses. For example, a user may have trusted IP addresses that match his or her home and workplace. When the server detects that the request has been sent with a trusted IP address, server 102 sends the email. In addition, or alternatively, when server 102 determines that a time that is less than a time threshold has elapsed between the validation of the last security test and the sending of a new request, server 102 sends the electronic mail. On the other hand, when server 102 determines that a time greater than a time threshold has elapsed between the validation of the last security test and the sending of a new request, server 102 does not send the electronic mail. Thus, it is possible to facilitate the sending of emails in certain situations that are not considered to be at risk. For example, if the IP address is unchanged, it can be assumed that the user is also unchanged. In addition, defining an elapsed time between two requests enables the user to send several emails successively without having to complete a security test multiple times in a short period. On the other hand, if a situation is considered to be at-risk, it is preferable to verify that the user is indeed the user associated with the email box from which the email is sent.

It is noted here that the steps described above in blocks 202a-210a may be performed at the moment when the mail client sends the electronic mail by STPM to server 102. In fact, due to the age of the technology and protocols used in sending emails, there is a delay between the moment the user clicks on “send” and the moment the recipient receives the email. Thus, it is possible to take advantage of this time period to complete these steps while avoiding an additional time delay.

FIG. 2b illustrates an example of method 200b for secure sending of an electronic mail. The method 200b may be implemented by the trusted device 104 described above.

At block 202b, method 200b consists of receiving, at a trusted device 104 associated with the user in response to receiving a request for transmission of an electronic mail by a server, a security test to be completed by the user via a secure channel. For example, when the server 102 receives the request from the user to send the electronic mail in the example of the method 200a described above, server 102 sends a security test to the trusted device 104 for it to be completed by the user. The test to be completed may, for example, be a notification for entering biometric data.

At block 204b, the method 200b consists of completing user security testing on the trusted apparatus 104. For example, after receiving a notification on his mobile phone 104 to enter his fingerprint, the user enters his fingerprint, using the device for generating biometric data present on his mobile phone 104.

At block 206b, method 200b consists of transmitting the security test, completed by the user, to server 102 via the secure channel for validation and transmission of the electronic mail by server 102 if the test is validated by the user. For example, if the security test completed by the user consists of entering biometric data, the trusted device 104 transmits the data obtained, to the server, or the comparison between the biometric data entered by the user with data stored on the trusted device 104 associated with the user, or else a result of the test (for example “validated” or “not validated”).

Thus, methods 200a, 200b described above make it possible to ensure that the user who sends the e-mail is indeed the person associated with the e-mail box from which the e-mail is sent. Thus, methods 200a and 200bB make it possible to avoid phishing and computer hacking of email boxes.

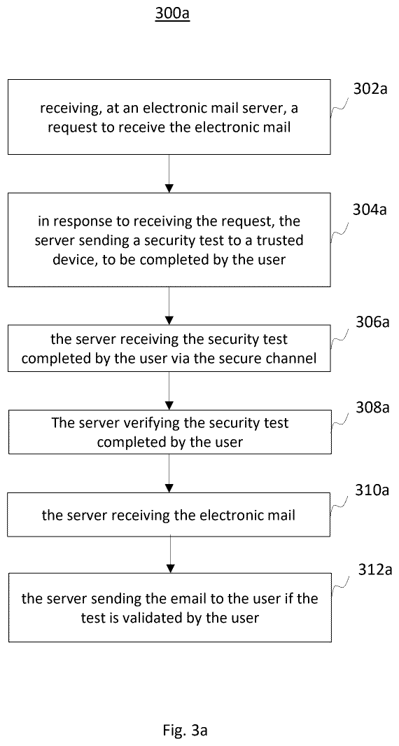

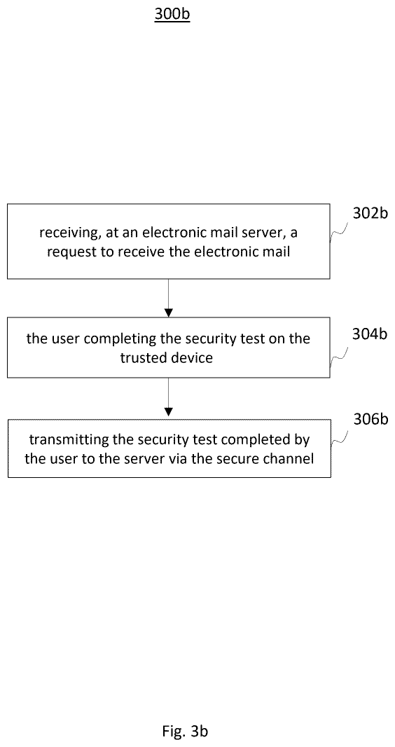

FIG. 3a illustrates an example of method 300a for secure reception of an email by a user. The method 300a may be implemented by the server 102 described above. In fact, server 102 can be used for the transmission and reception of electronic mails.

At block 302a, method 300a consists of receiving, at an electronic mail server, a request to receive the electronic mail, where the user has an electronic mail account on the electronic mail server, and where the user has previously identified himself with the electronic mail account. For example, a sender wants to send an email to the user. However, for example in case of confidentiality, it is important that this email be received by the right user.

At block 304a, method 300a consists of, in response to receiving the request, sending, using server 102,a security test to be completed by the user to a trusted device 104 associated with the user via a secure channel. For example, the user receives a notification on their phone to complete a security test, such as entering biometric data.

At block 306a, method 300a consists of server 102 receiving the security test completed by the user, via the secure channel. For example, server 102 receives the biometric data input by the user.

At block 308a, method 300a consists of the server verifying the security test completed by the user. For example, biometric data entered by the user are compared with biometric data associated with the user. If the data is similar, the test is validated and the user matches the recipient of the email. On the other hand, if the data are different, the test is not validated and the user does not correspond to the recipient of the email.

At block 310a, method 300a consists of receiving the electronic mail by the server.

At block 312a, method 300a consists of the server sending the electronic mail to the user, if the test is validated by the user. The user can therefore open the electronic mail. On the other hand, if the test is not validated, server 102 does not send the email to the recipient and rejects the message. For example, an error message appears on the screen of the user's computer.

FIG. 3b illustrates an example of method 300b for secure reception of an email by a user. The method 300b may be implemented by the trust apparatus 104 described above. In fact, trusted device 104 can be used for the transmission and reception of electronic mails.

At block 302b, method 300b consists of receiving, at a secure device 104 associated with the user, in response to the receipt of a request to receive an electronic mail by a server 102, a security test to be completed by the user via a secure channel. For example, the user receives a notification to enter his biometric data or a password.

At block 304b, method 300b consists of the user completing the security test on the trusted device 104. For example, the user enters his biometric data on his mobile phone.

At block 306b, method 300b consists of transmitting the security test completed by the user to the server via the secure channel for validation and transmission of the mail to the user by the server if the test is validated by the user. For example, if the security test completed by the user consists of entering biometric data, the trusted device 104 transmits the data obtained, to the server, or comparing the biometric data entered by the user with data stored on the trusted device 104 associated with the user or otherwise of a result of the test (for example “validated” or “not validated”).

It is noted here that the methods 300a and 300b can be implemented in combination with the methods 200a, 200b or separately. In addition, methods 300a and 300b may be implemented by the system 100 described above. Just as for methods 200a and 200b, it is also possible to define a safety parameter in method 300. For example, a time lapse between two requests to receive an email can be set to avoid the need for the user to complete a test when several emails are received in a short time. In fact, method 300a can also consist of receiving, at e-mail server 102, another request from the user to send another e-mail, verifying a predetermined security parameter and sending the e-mail using the server if the predetermined security parameter is satisfied. For example, the security parameter may include a number of emails, an elapsed time between the validation of the last security test, suspicious behaviour of the user, and the sending of a new request, a change of IP address used by the user since the validation of the last security test, and a date when the request is sent by the user.

Thus, method 300a makes it possible to ensure that the electronic mail is received by the person for whom it is intended. For example, if several users are using the same device (such as a computer), it may be important to ensure that only one of the users can access his email box and confidential emails for example. In addition, the method 300a makes it possible to ensure that the user does not receive unwanted mail.

It should be understood that the manners of embodiment of the present invention may be implemented by a computer program product consisting of instructions and executed by a computer. For example, the methods 200a, 200b, 300a, and 300b may be implemented using computing devices, software, and/or a combination thereof. For example, the computing devices may be implemented using processing circuitry such as, but not limited to, a processor, a central processing unit (CPU), a controller, an arithmetic and logic unit (ALU), a digital signal processor, a microcomputer, a field programmable gate array (FPGA), a system on a chip (SoC), a programmable logic unit, a microprocessor, or any other device capable of responding to and executing instructions in a defined manner. The software may include a computer programme, programme code, instructions, or a combination thereof, for independently or collectively instructing or configuring a hardware device to operate as desired. The computer programme and/or programme code may include programme or computer-readable instructions, software components, software modules, data files, data structures, and/or the like, which may be implemented by one or more hardware devices, such as one or more of the aforementioned hardware peripherals. When a hardware device is a computer processing device (e.g., CPU, controller, ALU, digital signal processor, microcomputer, microprocessor, etc.), the computer processing device may be configured to execute programme code by performing arithmetic, logic, and input/output operations, depending on to the programme code. The control unit 106 may also consist of one or more storage devices. The storage device(s) may be tangible or non-transitory computer-readable storage media, such as random access memory (RAM), read-only memory (ROM), permanent mass storage device (such as a disk drive), (e.g. NAND flash) and/or any other similar data storage mechanism capable of storing and recording data. The storage device(s) may be configured to store computer programmes, programme code, instructions, or a combination thereof, for one or more operating systems, and/or to implement the examples of manners of embodiment described herein. The computer programmes, programme code, instructions, or combination thereof may also be loaded from a separate computer-readable storage medium into the storage device(s) and/or one or more computer processing devices, using a drive mechanism. Such a separate computer-readable storage medium may comprise a USB (Universal Serial Bus) stick, a memory stick, a Blu-ray/DVD/CD-ROM player, a memory card and/or other computer-readable storage media.

Although the invention has been illustrated and described in detail with the aid of preferred manners of embodiment, the invention is not limited to the examples disclosed. Other variants can be deduced by those skilled in the art without departing from the scope of protection of the claimed invention. For example, although the methods 200a, 200b and the methods 300a and 300b have been described separately, they can be used by the same system. Moreover, although the computer on which the user writes his electronic mail and the trusted apparatus have been described as being two different devices, they may be the same device.

1. A method of securely sending an electronic mail, the method comprising:
receiving, at a trusted device associated with the user in response to receiving a request for transmission, by a server, of an electronic mail, a security test to be completed by the user via a secure channel;
the user completing the security test user on the trusted device;
transmitting the security test completed by the user to the server, via the secure channel for validation and transmission of the email by the server, if the test is validated by the user.

2. Method for securely sending an electronic mail according to claim 1, in which the security test comprises a comparison of a biometric input with biometric data associated with the user and stored on the trusted device associated with the user.

3. Method for securely sending an electronic mail according to claim 1, in which the trusted device associated with the user is a mobile telephone or a USB key.

4. Method of securely sending an electronic mail according to claim 1, wherein the trusted device comprises an application for completing the security test.

5. A trusted device for securely sending an electronic mail, with the trusted device being configured to implement the method of claim 1.

6. A method of securely receiving an email from a user, the method comprising:
a server receiving, at a trusted device associated with the user, in response to receiving a request to receive an electronic mail, a security test to be completed by the user via a secure channel; and
the completing the security test on the trusted device;
transmitting the security test completed by the user to the server, via the secure channel for validation and transmission of the mail to the user by the server, if the test is validated by the user.
